(19) United States
(12) Patent Application Publication
(10) Pub. No.: US 2018/0227888 A1
(43) Pub. Date: Aug. 9, 2018

(54) TECHNIQUES OF DECODING AGGREGATED DCI MESSAGES

(71) Applicant: Mediatek Inc., Hsin-Chu (TW)

(72) Inventors: Chien Hwa Hwang, Hsinchu (TW); Pei-Kai Liao, Hsinchu (TW); Wei-De Wu, Hsinchu (TW)

(21) Appl. No.: 15/888,256

(22) Filed: Feb. 5, 2018

Related U.S. Application Data
(60) Provisional application No. 62/458,043, filed on Feb. 13, 2017.
(60) Provisional application No. 62/455,051, filed on Feb. 6, 2017.

(51) Int. Cl. H04W 72/04; H04L 5/00; H04L 1/00

(52) U.S. Cl. CPC H04W 72/042; H04L 1/0061; H04L 1/0045; H04L 5/0037

(57) ABSTRACT

In an aspect of the disclosure, a method, a computer-readable medium, and an apparatus are provided. The apparatus may be a UE. The first UE receives data bits representing downlink control information from a base station. The first UE also determines a first set of bits of the data bits. The first set of bits indicates whether the received data bits include G sets of bits representing downlink control information directed to one or more UEs, G being an integer greater than 1. The first UE further processes at least one set of bits of the G sets of bits to obtain downlink control information directed to the first UE when the data bits include the G sets of bits.

### CROSS-REFERENCE TO RELATED APPLICATION(S)

This application claims the benefit of U.S. Provisional Application Ser. No. 62/455,051, entitled “AGGREGATION OF DOWNLINK CONTROL INFORMATION” and filed on Feb. 6, 2017, and U.S. Provisional Application Ser. No. 62/458,043, entitled “BLIND DECODING FOR DCI AGGREGATION” and filed on Feb. 13, 2017, which are expressly incorporated by reference herein in their entirety.

### BACKGROUND

### Field

The present disclosure relates generally to communication systems, and more particularly, to user equipment (UE) that decodes aggregated DCI messages in a transmission from a base station.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives data bits representing downlink control information from a base station. The UE also determines a first set of bits of the data bits. The first set of bits indicates whether the received data bits include G sets of bits representing downlink control information directed to one or more UEs, G being an integer greater than 1. The UE further processes at least one set of bits of the plurality of sets of bits to obtain downlink control information directed to the first UE when the data bits include the plurality of sets of bits.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating a base station in communication with a UE in an access network.

FIG. 4 illustrates an example logical architecture of a distributed access network.

FIG. 5 illustrates an example physical architecture of a distributed access network.

FIG. 6 is a diagram showing an example of a DL-centric subframe.

FIG. 7 is a diagram showing an example of an UL-centric subframe.

FIG. 8 is a diagram illustrating communications between a base station and UE.

FIG. 9 is diagram illustrating a format of aggregated/combined DCI messages in accordance with a first technique.

FIG. 10 is diagram illustrating a format of aggregated/combined DCI messages in accordance with a second technique.

FIG. 11 is a flow chart of a method (process) for processing aggregated DCI messages.

FIG. 12 is a flow chart of another method (process) for processing aggregated DCI messages.

FIG. 13 is a conceptual data flow diagram illustrating the data flow between different components/means in an exemplary apparatus.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

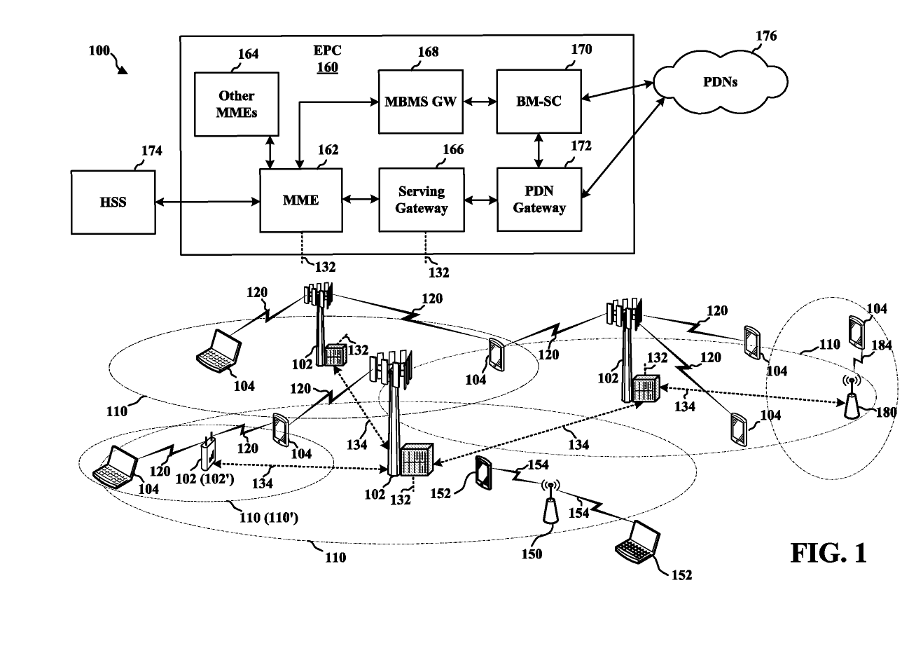

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In certain aspects, the base station 102 generates a plurality of sets of bits representing downlink control information directed to a plurality of UEs. The each set of bits of the plurality of sets of bits includes a number of information bits and a number of protection bits. The base station 102 also combines the plurality of sets of bits to generate combined bits. The base station 102 further encodes the combined bits to generate encoded bits. The base station 102 subsequently transmits the encoded bits.

In certain aspects, the UE 104 receives data bits representing downlink control information from a base station. The UE 104 also determines a first set of bits of the data bits. The first set of bits indicates whether the received data bits include plurality of sets of bits representing downlink control information directed to one or more UEs, G being an integer greater than 1. The UE 104 further processes at least one set of bits of the plurality of sets of bits to obtain downlink control information directed to the first UE when the data bits include the plurality of sets of bits.

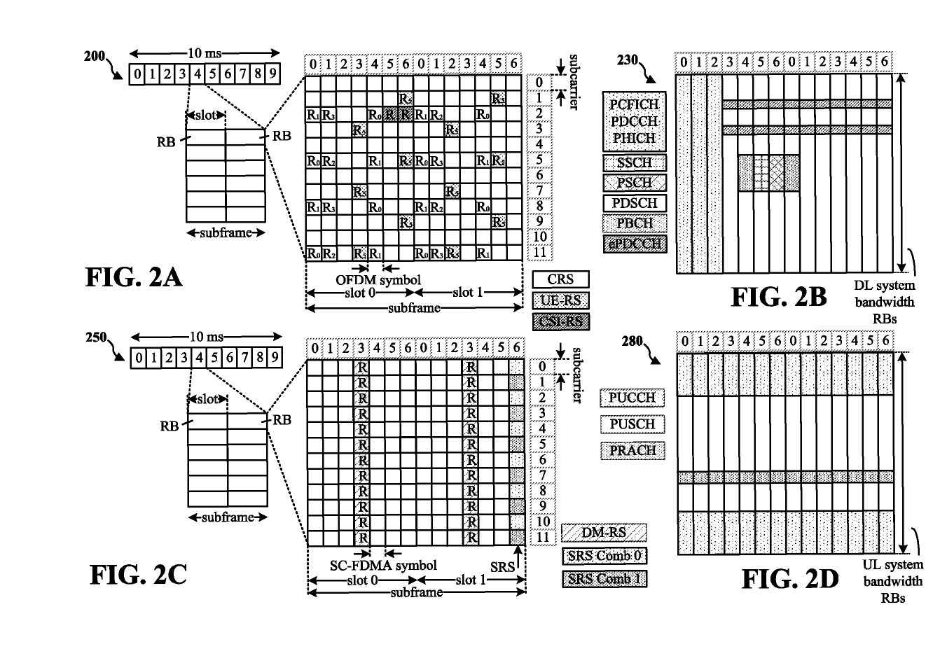

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R0, R1, R2, and R3, respectively), UE-RS for antenna port 5 (indicated as R5), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

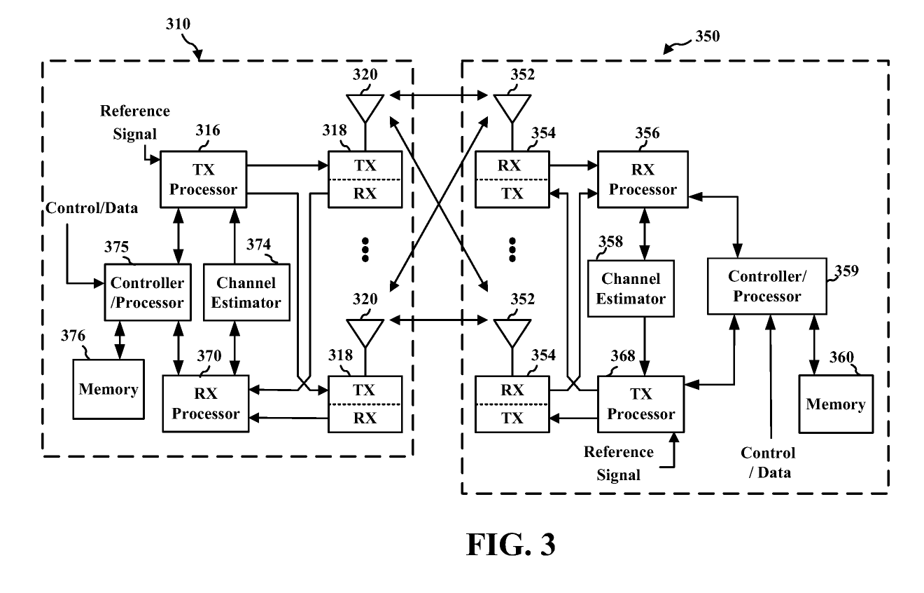

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission. The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

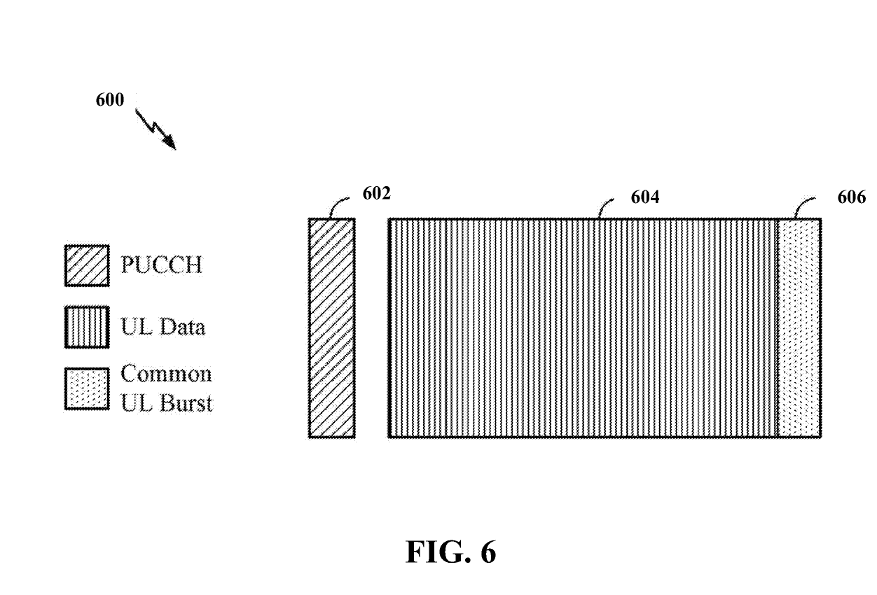

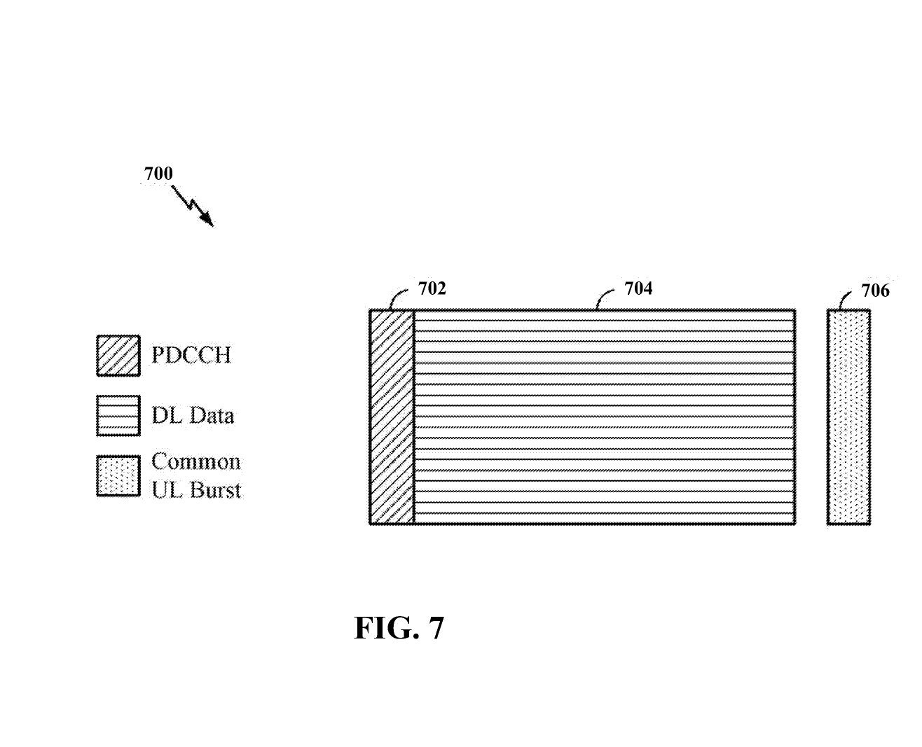

A single component carrier bandwidth of 100 MHZ may be supported. In one example, NR resource blocks (RBs) may span 12 sub-carriers with a sub-carrier bandwidth of 75 kHz over a 0.1 ms duration or a bandwidth of 15 kHz over a 1 ms duration. Each radio frame may consist of 10 or 50 subframes with a length of 10 ms. Each subframe may have a length of 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

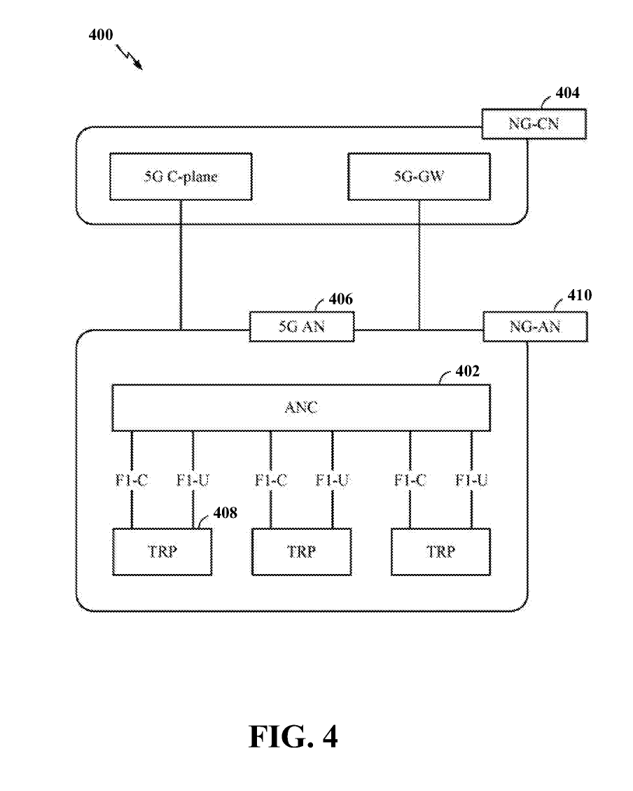

FIG. 4 illustrates an example logical architecture 400 of a distributed RAN, according to aspects of the present disclosure. A 5G access node 406 may include an access node controller (ANC) 402. The ANC may be a central unit (CU) of the distributed RAN 400. The backhaul interface to the next generation core network (NG-CN) 404 may terminate at the ANC. The backhaul interface to neighboring next generation access nodes (NG-ANs) may terminate at the ANC. The ANC may include one or more TRPs 408 (which may also be referred to as BSs, NR BSs, Node Bs, 5G NBs, APs, or some other term). As described above, a TRP may be used interchangeably with “cell.”

The TRPs 408 may be a distributed unit (DU). The TRPs may be connected to one ANC (ANC 402) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 400 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 410 may support dual connectivity with NR. The NG-AN may share a common fronthaul for LTE and NR.

The architecture may enable cooperation between and among TRPs 408. For example, cooperation may be preset within a TRP and/or across TRPs via the ANC 402. According to aspects, no inter-TRP interface may be needed/present.

According to aspects, a dynamic configuration of split logical functions may be present within the architecture of the distributed RAN 400. The PDCP, RLC, MAC protocol may be adaptably placed at the ANC or TRP.

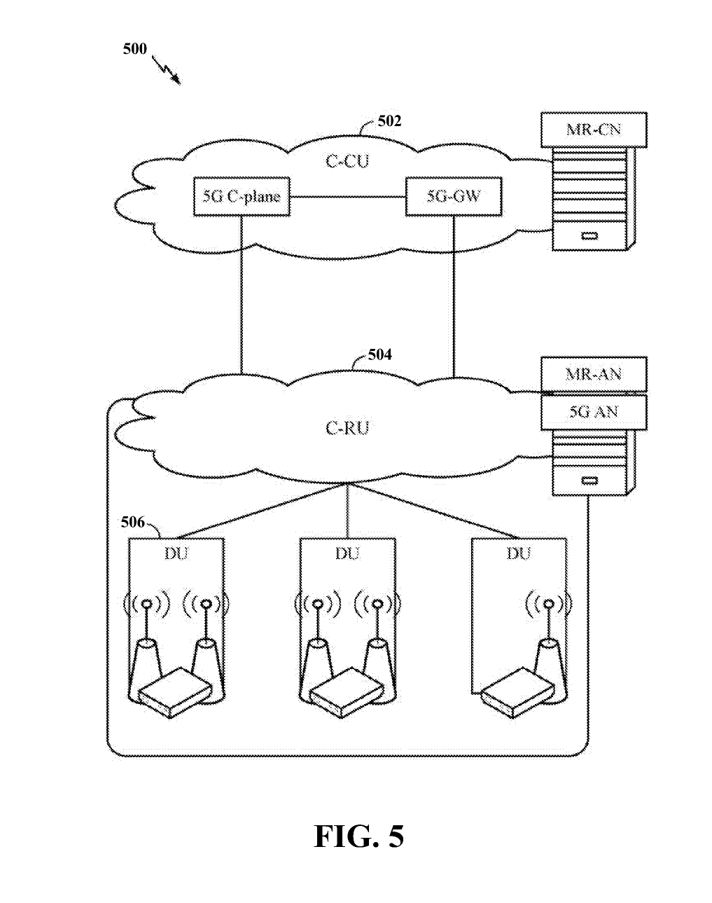

FIG. 5 illustrates an example physical architecture of a distributed RAN 500, according to aspects of the present disclosure. A centralized core network unit (C-CU) 502 may host core network functions. The C-CU may be centrally deployed. C-CU functionality may be offloaded (e.g., to advanced wireless services (AWS)), in an effort to handle peak capacity. A centralized RAN unit (C-RU) 504 may host one or more ANC functions. Optionally, the C-RU may host core network functions locally. The C-RU may have distributed deployment. The C-RU may be closer to the network edge. A distributed unit (DU) 506 may host one or more TRPs. The DU may be located at edges of the network with radio frequency (RF) functionality.

FIG. 6 is a diagram 600 showing an example of a DL-centric subframe. The DL-centric subframe may include a control portion 602. The control portion 602 may exist in the initial or beginning portion of the DL-centric subframe. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe may also include a DL data portion 604. The DL data portion 604 may sometimes be referred to as the payload of the DL-centric subframe. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information.

As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 7 is a diagram 700 showing an example of an UL-centric subframe. The UL-centric subframe may include a control portion 702. The control portion 702 may exist in the initial or beginning portion of the UL-centric subframe. The control portion 702 in FIG. 7 may be similar to the control portion 702 described above with reference to FIG. 6. The UL-centric subframe may also include an UL data portion 704. The UL data portion 704 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 702 may be a physical UL control channel (PUCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 706. The common UL portion 706 in FIG. 7 may be similar to the common UL portion 706 described above with reference to FIG. 7. The common UL portion 706 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum)

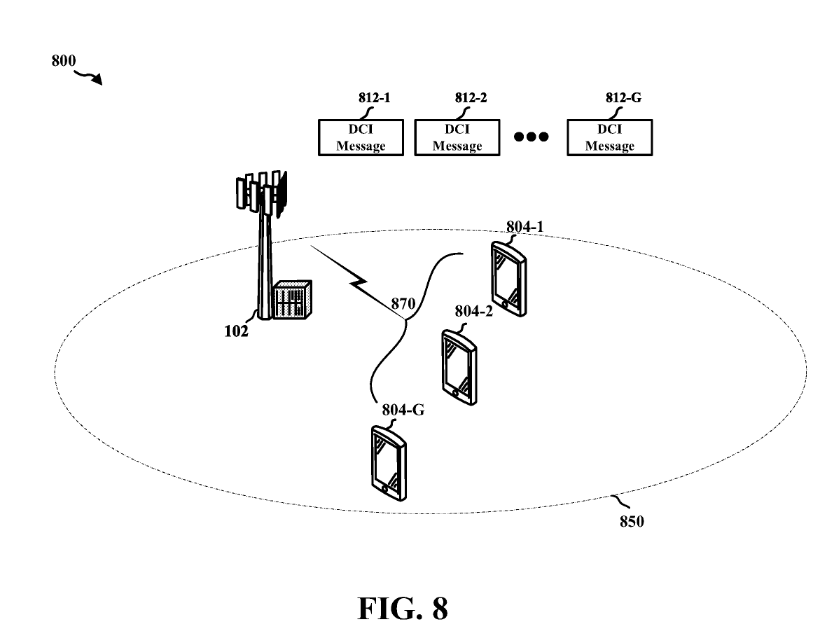

FIG. 8 is a diagram 800 illustrating communications between a base station 102 and UEs 804-1, 804-2, . . . 804-G that are in a cell 850 of the base station 102. In certain configurations, as described infra, the UEs 804-1, 804-2, . . . 804-G may belong to a UE group 870. The base station 102 may transmit one or more DCI messages directed to one or more of the UEs 804-1, 804-2, . . . 804-G via the PDCCH illustrated in FIG. 2B. As an example, the base station 102 may determine to transmit DCI messages 812-1, 812-2, . . . 812-G, which are directed to the UEs 804-1, 804-2, . . . 804-G and contain downlink control information to be used by the UEs 804-1, 804-2, . . . 804-G, respectively.

In certain configurations, as described infra, the base station 102 may combine the DCI messages 812-1, 812-2, . . . 812-G to generate combined bits. The base station 102 then may encode the combined bits and transmit the encoded bits to the UEs 804-1, 804-2, . . . 804-G.

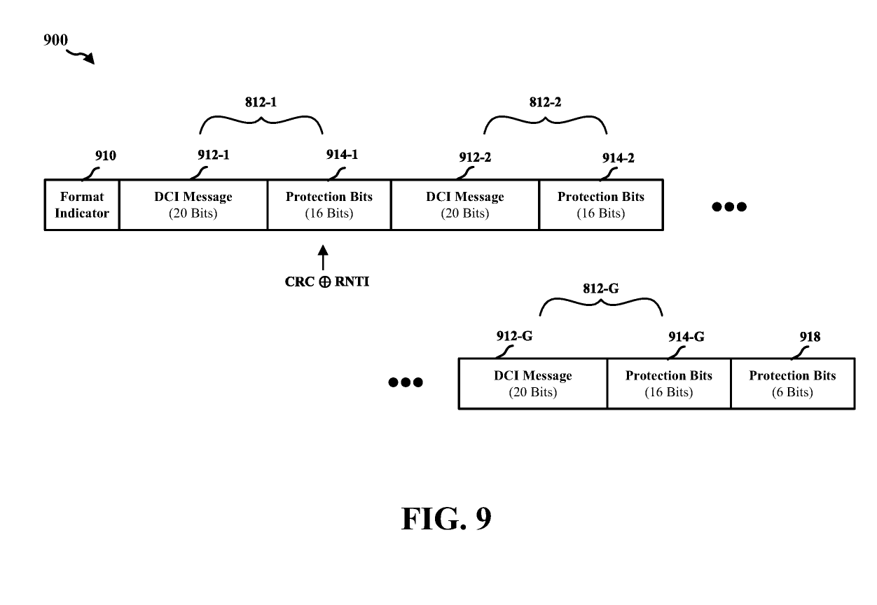

FIG. 9 is diagram 900 illustrating a format of aggregated/combined DCI messages in accordance with a first technique. In this technique, the base station 102 initially generates information bits 912-1 of the DCI message 812-1. For example, the information bits 912-1 may be 20-bit long. Further, the base station 102 generates protection bits 914-1 (or other error-detection code) of the information bits 912-1. More specifically, the base station 102 generates a CRC of the information bits 912-1. For example, the CRC is 16-bit long. Further, in this example, the DCI message 812-1 is directed to the UE 804-1. That is, the DCI message 812-1 carries downlink control information to be used by the UE 804-1. The base station 102 thus obtains the Radio Network Temporary Identifier (RNTI) of the UE 804-1. For example, the RNTI may be also 16-bit long. Then, the base station 102 uses the RNTI to scramble the CRC to generate the protection bits 914-1, which may be 16-bit long. In particular, the base station 102 can apply an exclusive-or operation to the CRC and the RNTI to generate the protection bits 914-1. The base station 102 appends the protection bits 914-1 to the DCI message 812-1.

The base station 102 similarly generates the information bits and the protection bits for each of the rest of the DCI messages 812-1, 812-2, . . . 812-G. That is, the base station 102 generates information bits 912-2 and protection bits 914-2 of the DCI message 812-2, and so on, until the base station 102 has generated information bits 912-G and protection bits 914-G of the DCI message 812-G.

The base station 102 concatenates (or aggregates) the information bits and the protection bits of each one of the DCI messages 812-1, 812-2, . . . 812-G together to generate combined bits. For example, the base station 102 may append the protection bits 914-1 to the information bits 912-1. Then, the base station 102 appends the information bits 912-2 and the protection bits 914-2 to the combined bits, and so on, until the base station 102 has appended the information bits 912-G and the protection bits 914-G to the combined bits.

In addition, the base station 102 may generate protection bits 918 for the combined bits (which contain the information bits and the protection bits of the DCI messages 812-1, 812-2, . . . 812-G) collectively. In particular, the protection bits 918 may be a 6-bit long CRC for the combined bits as a whole.

The base station 102 may generate DCI messages of different sizes. Accordingly, as described infra, the UEs 804-1, 804-2, . . . 804-G may be configured to monitor downlink control information messages of different sizes. In certain configurations, the total number of combined bits for a first number of DCI messages having a first size may be the same as that of a second number of DCI messages having a second, different size. For example, the information bits of a DCI message may have a size of 20-bit, 56-bit, etc. As such, the total number of bits (i.e., including information bits and the protection bits of each message as well as the protection bits 918) for two 20-bit DCI messages are 78; the total number of bits for a single 56-bit DCI messages are 78, as well.

In this technique, the base station 102 may generate a format indicator 910 that indicates the format of the combined bits. The format indicator 910 may include a pre-configured number of bits (e.g., 1 bit, 2 bits, 3 bits, etc.). The value of the format indicator 910 indicates the format of the combined bits. For example, the size of the format indicator 910 may be one bit. The value of “0” indicates that the combined bits include only one message. The value “1” indicates that the combined bits includes two messages. As such, in the example described supra, the total number of combined bits is 79, including the format indicator 910 (e.g., 1 bit), the information bits and the protection bits of the DCI messages (e.g., 72 bits), and the protection bits 918 (e.g., 6 bits).

In another example, when the base station 102 only transmits data bits (including information bits and protection bits) for a single DCI message and does not aggregate multiple DCI messages in a single transmission, the base station 102 may not generate the protection bits 918 for the single DCI message. In certain configurations, the number of data bits for a single DCI message having a larger size and without protection bits 918 may be the same as the number of data bits for multiple DCI messages having a smaller size and including the protection bits 918. Accordingly, the base station 102 generates a format indicator 910 to be included in the data bits to indicate the number of DCI messages that are contained in the data bits.

Subsequently, in this example, the base station 102 inputs the combined bits to a Polar code encoder to generate encoded bits containing the DCI messages 812-1, 812-2, . . . 812-G. The base station 102 then maps the encoded bits to symbols carried in one or more Control-Channel Elements (CCEs). The base station 102 transmits those symbols to the UEs 804-1, 804-2, . . . 804-G. In certain configurations, one CCE may carry symbols represent 60 or 108 data bits, etc.

In one example for demonstrating the advantages that may be achieved by this technique, two DCI messages are aggregated and encoded by Polar coding. The DCI messages are transmitted over 8 CCEs from a base station to UE. Due to the channel coding gain enhancement attributed to DCI message aggregation, this transmission has a better performance comparing with transmission of one DCI messages over 4 CCEs with Tail-Biting Convolutional Coding (TBCC) or Polar coding.

In another example, 4 DCI messages are aggregated and encoded by Polar coding. The DCI messages are transmitted over 8 CCEs from a base station to UE. Due to the channel coding gain enhancement attributed to DCI message aggregation, this transmission has a better performance comparing with transmission of one DCI messages over 2 CCEs with TBCC or Polar coding.

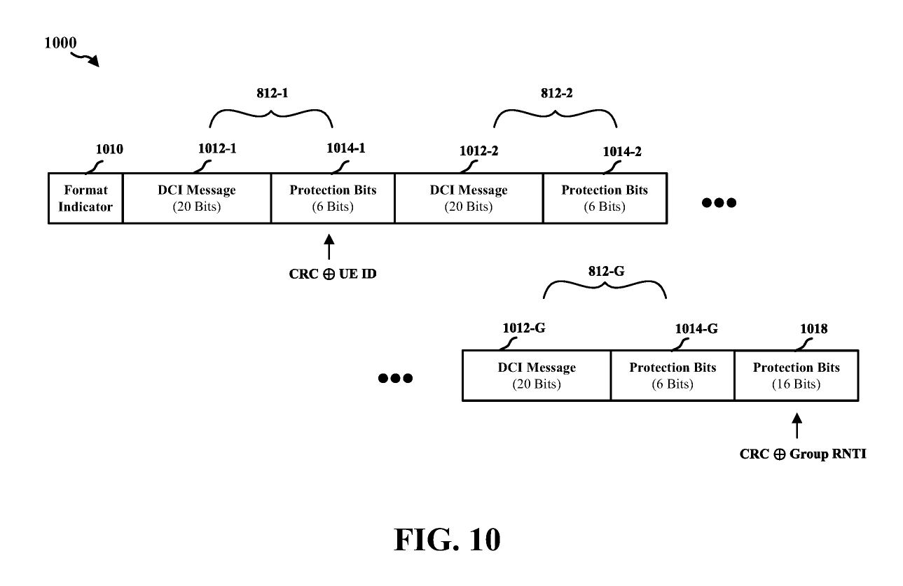

FIG. 10 is diagram 1000 illustrating a format of aggregated/combined DCI messages in accordance with a second technique. In this example, the UEs 804-1, 804-2, . . . 804-G are in the cell 850 and belong to the same UE group 870 managed by the base station 102. The base station 102 may assign to the UE group 870 a RNTI such as a DCI aggregation group (DAG)-RNTI for identification. As one example, the DAG-RNTI may be 16-bit long. Further, the base station 102 may use a UE identifier (e.g., an index) to uniquely identify each UE within the UE group 870. As one example, the identifier may be 6-bit long. For example, the UE 804-1 may have an index “0,” the UE 804-2 may have an index “1,” and so on. As such, a combination of the UE group 870 and the UE identifier (e.g., index) of a particular UE uniquely identifies that UE.

In this second technique, the base station 102 initially generates information bits 1012-1 of the DCI message 812-1. The information bits 1012-1 may be 20-bit long. Further, the base station 102 generates protection bits 1014-1 (or other error-detection code) of the information bits 1012-1. More specifically, the base station 102 generates a CRC of the information bits 1012-1. In this example, the CRC is 6-bit long.

The DCI messages 812-1, 812-2, . . . 812-G are directed to the UEs 804-1, 804-2, . . . 804-G, respectively. That is, the DCI message 812-1 carries downlink control information to be used by the UE 804-1; the DCI message 812-2 carries downlink control information to be used by the UE 804-2, and so on. To generate protection bits of the DCI message 812-1, the base station 102 obtains the identifier (e.g., index) of the UE 804-1. The identifier may be 6-bit long. The base station 102 uses the identifier to scramble the CRC to generate the protection bits 1014-1. For example, the base station 102 can apply an exclusive-or operation to the CRC and the identifier of the UE 804-1 to generate the protection bits 1014-1. The base station 102 may append the protection bits 1014-1 to the information bits 1012-1.

The base station 102 similarly generates the information bits and the protection bits for each of the rest of the DCI messages 812-1, 812-2, . . . 812-G. That is, the base station 102 generates information bits 1012-2 and protection bits 1014-2 of the DCI message 812-2, and so on, until the base station 102 has generated information bits 1012-G and protection bits 1014-G of the DCI message 812-G.

The base station 102 concatenates (or aggregates) the information bits and the protection bits of each one of the DCI messages 812-1, 812-2, . . . 812-G together to generate combined bits. For example, the base station 102 may append the protection bits 1014-1 to the information bits 1012-1. Then the base station 102 appends the information bits 1012-2 and the protection bits 1014-2 to the combined bits, and so on, until the base station 102 has appended the information bits 1012-G and the protection bits 1014-G to the combined bits.

In addition, the base station 102 may generate protection bits 1018 for the combined bits containing the information bits and the protection bits of the DCI messages 812-1, 812-2, . . . 812-G collectively. In particular, the protection bits 1018 may be 16-bit long. To generate the protection bits 1018, the base station 102 initially generates a 16-bit CRC for the combined bits as a whole. The base station 102 then uses a 16-bit group RNTI (e.g., the DAG-RNTI) of the UE group 870 to scramble the CRC to generate the protection bits 1018. For example, the base station 102 can apply an exclusive-or operation to the CRC and the DAG-RNTI to generate the protection bits 1018. The base station 102 appends the protection bits 1018 to the combined bits.

As described supra, the base station 102 may generate DCI messages of different sizes. Accordingly, as described infra, the UEs 804-1, 804-2, . . . 804-G may be configured to monitor downlink control information messages of different sizes. In certain configurations, the total number of combined bits for a first number of DCI messages of a first size may be the same as that of a second number of DCI messages of a second, different size.

Similarly, in this second technique, the base station 102 may generate a format indicator 1010 that indicates the format of the combined bits. The format indicator 1010 may include a pre-configured number of bits. The value of the format indicator 1010 indicates the format of the combined bits. For example, the size of the format indicator 1010 may be one bit. The value of “0” indicates that the combined bits contains only one message. The value “1” indicates that the combined bits contains two messages.

Subsequently, the base station 102 inputs the combined bits to a Polar code encoder to generate encoded bits containing the DCI messages 812-1, 812-2, . . . 812-G. The base station 102 then maps the encoded bits to symbols carried in one or more CCEs. In certain configurations, one CCE may carry symbols represent 60 or 108 data bits, etc. The base station 102 transmits those symbols to the UEs 804-1, 804-2, . . . 804-G.

Referring back to FIGS. 8 and 9, the UE 804-1 may receive encoded bits from the base station 102. The UE 804-1 decodes the encoded bits to generate data bits. As described infra, the UE 804-1 can determine that the received data bits are combined bits containing the DCI messages 812-1, 812-2, . . . 812-G. The combined bits may be generated by the base station 102 in accordance with the techniques described supra. In certain configurations, the UE 104 and the base station 102 are configured to implement the first technique described supra referring to FIG. 9. As described supra, the UE 804-1 can monitor DCI messages of different sizes. In particular, the UE 804-1 processes information bits, of a DCI message, having one of a list of sizes. For example, the UE 104 may monitor information bits, of a DCI message, that are 20-bit or 56-bit long.

More specifically, the UE 804-1 may receive a particular number of data bits transmitted from the base station 102. The particular number of data bits may be a first number of DCI messages of a first size or a second number of DCI messages of a second size. As described supra, the data bits include a format indicator 910 to indicate the format of the data bits. Based on the value of the format indicator 910, the UE 804-1 can determine the format of the data bits, such as the number of DCI messages included in the data bits, the locations of the information bit and the protection bits of each DCI message, and the locations of the protection bits 918.

For example, the data bits received from the base station 102 may be 79-bit long, with the first bit functions as the format indicator 910. When the format indicator 910 is “0”, the UE 804-1 determines that the data bits include a single DCI message 812-1 having 56 information bits and 16 protection bits. The data bits also include a CRC of 6-bit long for the information bits 912-1 and the protection bits 918 collectively. Accordingly, the UE 804-1 calculates a CRC based on the bits from the second bit to the 73⁶ bit (i.e., the information bits 912-1 and the protection bits 914-1). The UE 804-1 compares the calculated CRC with the bits from the 74^{th} bit to the 79^{th} bit (i.e., the protection bits 918) of the received data bits to determine the integrity of the DCI message 812-1. If those bits match, the UE 804-1 can determine that the integrity of the of the received data bits is intact.

When the integrity of the of the received data bits is intact, the UE 804-1 then locates the protection bits 914-1 and descramble the protection bits 914-1 with the RNTI the UE 804-1 to generate descrambled bits. The UE 804-1 also calculated a CRC of the information bits 912-1. If the calculated CRC matches the descrambled bits, the UE 804-1 can determine that the DCI message 812-1 represented by the information bits 912-1 is directed to the UE 804-1. Accordingly, the UE 804-1 obtains downlink control information (including downlink scheduling commands, uplink scheduling grants, and uplink power control commands) from the DCI message 812-1. When necessary, the UE 804-1 adjusts its operation according to the downlink control information.

When the format indicator 910 is “1”, the UE 804-1 determines that the 79-bit long data bits include two DCI messages: the DCI message 812-1 and the DCI message 812-2. Accordingly, the UE 804-1 can determine the locations of the information bits 912-1, the protection bits 914-1, the information bits 912-2, the protection bits 914-2, and the protection bits 918. Similarly to what was described supra, the UE 804-1 compares a calculated CRC for the DCI message 812-1 and the DCI message 812-2 with the protection bits 918 to determine the integrity of the bits of the DCI message 812-1 and the DCI message 812-2 collectively.

If the integrity is intact, the UE 804-1 then uses the RNTI of the UE 804-1 to descramble the protection bits 914-1 (corresponding to the DCI message 812-1 and 16-bit long) to generate descrambled bits (e.g., 16-bit long). The UE 804-1 then compares the descrambled bits with a CRC (e.g., 16-bit long) calculated from the information bits 912-1.

If the calculated CRC matches the descrambled bits, the UE 804-1 can determine that the DCI message 812-1 represented by the information bits 912-1 is directed to the UE 804-1. Accordingly, the UE 804-1 obtains downlink control information (including downlink scheduling commands, uplink scheduling grants, and uplink power control commands) from the DCI message 812-1. When necessary, the UE 804-1 adjusts its operation according to the downlink control information.

If the descrambled bits from the protection bits 914-1 do not match the CRC of the information bits 912-1, the UE 804-1 then descrambles protection bits of another DCI message. In this example, the UE 804-1 uses the RNTI of the UE 804-1 to descramble the protection bits 914-2 corresponding to the DCI message 812-2. The UE 804-1 compares a calculated CRC of the information bits 912-2 with the descrambled bits from the protection bits 914-2 to determine whether the information bits 912-2 are directed to the UE 804-1.

In one configuration, the base station 102 only includes one DCI message directed to a particular UE in one submission. In this configuration, the UE 804-1 may decide to stop blind decoding the rest of the DCI messages after the UE 804-1 successfully decoded one DCI message directed to the UE 804-1. In another configuration, the base station 102 may include multiple DCI messages for a particular UE in one transmission. In this configuration, the UE 804-1 may perform blind decoding for each of the DCI messages included in the transmission to obtain all DCI messages directed to the UE 804-1.

Referring back to FIGS. 8 and 10, in certain configurations, the UE 104 and the base station 102 are configured to implement the second technique described supra referring to FIG. 10. As described supra, the UE 804-1 can monitor DCI messages having information bits of a list of sizes. The UE 804-1 may receive a particular number of data bits transmitted from the base station 102. The particular number of data bits may be a first number of DCI messages of a first size or a second number of DCI messages of a second size. As described supra, the data bits include a format indicator 1010 to indicate the format of the data bits. Based on the value of the format indicator 1010, the UE 804-1 can determine the format of the data bits, such as the number of DCI messages included in the data bits, the locations of the information bit and the protection bits of each DCI message, and the locations of the protection bits 1018.

The UE 804-1 initially determines the locations of the bits that functions as the format indicator 1010 based on, for example, a configuration of the UE 804-1. Subsequently, the UE 804-1 determines the format of data bits according to the value of the format indicator 1010. In this example, the UE 804-1 determines that the data bits contain the DCI messages 812-1, 812-2, . . . 812-G. The data bits also include the protection bits 1018 (e.g., 16-bit long) for the information bits and the protection bits of the DCI messages 812-1, 812-2, . . . 812-G (e.g., the information bits 1012-1, 1012-2, . . . 1012-G and the protection bits 1014-1, 1014-2, . . . 1014-G) collectively. The UE 804-1 belongs to the UE group 870 and uses a pre-configured group RNTI (e.g., 16-bit DAG-RNTI) of the UE group 870 to descramble the protection bits 1018 to generated descrambled bits. Further, the UE 804-1 calculates a 16-bit CRC based on the bits of the DCI messages 812-1, 812-2, . . . 812-G.

The UE 804-1 compares the calculated CRC with the descrambled bits to determine the integrity of the received data bits. If the calculated CRC and the descrambled bits match, the UE 804-1 can determine that the integrity of the received data bits is intact.

The UE 804-1 then locates the protection bits 1014-1. The UE 804-1 uses the identifier (e.g., an index) of the UE 804-1 within the UE group 870 to descramble the protection bits 1014-1 to generate 6-bit descrambled bits. The UE 804-1 also calculates a 6-bit CRC of the information bits 1012-1. If the calculated CRC of the information bits 1012-1 matches the descrambled bits from the protection bits 1014-1, the UE 804-1 can determine that the DCI message 812-1 represented by the information bits 1012-1 is directed to the UE 804-1. Accordingly, the UE 804-1 obtains downlink control information (including downlink scheduling commands, uplink scheduling grants, and uplink power control commands) from the DCI message 812-1. When necessary, the UE 804-1 adjusts its operation according to the downlink control information.

If the descrambled bits do not match the CRC of the information bits 1012-1, the UE 804-1 then processes bits of another DCI message. For example, the UE 804-1 can compare a calculated CRC of the information bits 1012-2 with the descrambled bits from the protection bits 1014-2 to determine whether the information bits 1012-2 are directed to the UE 804-1.

In one configuration, the base station 102 only includes one DCI message directed to a particular UE in one submission. In this configuration, the UE 804-1 may decide to stop blind decoding the rest of the DCI messages after the UE 804-1 successfully decoded one DCI message directed to the UE 804-1. In another configuration, the base station 102 may include multiple DCI messages for a particular UE in one transmission. In this configuration, the UE 804-1 may perform blind decoding for each of the DCI messages included in the transmission to obtain all DCI messages directed to the UE 804-1.

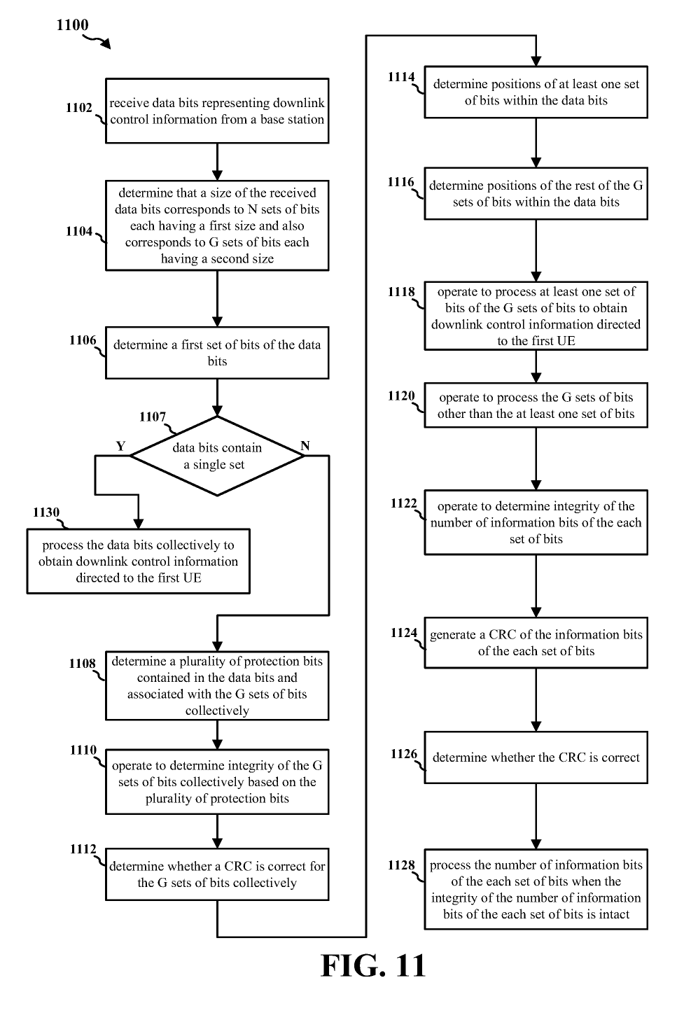

FIG. 11 is a flow chart 1100 of a method (process) for processing aggregated DCI messages. The method may be performed by a first UE (e.g., any of the UEs 804-1, 804-2, . . . 804-G, the apparatus 1302, and the apparatus 1302′). At operation 1102, the first UE receives data bits representing downlink control information from a base station (e.g., the base station 102). In certain configurations, the first UE is pre-configured to monitor the received data bits having one of a list of sizes. At operation 1104, the first UE determines that a size (e.g., 79 bits) of the received data bits corresponds to N sets of bits (e.g., one set including information bits and protection bits of one DCI message) each having a first size (e.g., 72 bits) of the list of sizes and also corresponds to G sets of bits (e.g., two sets including information bits and protection bits of two DCI messages) each having a second size (e.g., 36 bits) of the list of sizes, N being an integer greater than 0, G being an integer greater than 1. The G sets of bits represents downlink control information directed to one or more UEs. At operation 1106, the first UE determines a first set of bits (e.g., the format indicator 910) of the data bits. The first set of bits indicates whether the received data bits include the G sets of bits.

At operation 1107, the first UE determines whether the received data bits contain a single set of bits or multiple sets of bits. When the received data bits contain a single set of bits, the first UE, at operation 1130, processes the data bits collectively to obtain downlink control information directed to the first UE.

When the received data bits contain the G sets of bits (e.g., the information bits and the protection bits of the DCI messages 812-1, 812-2, . . . 812-G), the first UE, at operation 1108, determines a plurality of protection bits (e.g., the protection bits 918) contained in the data bits and associated with the G sets of bits collectively. At operation 1110, the first UE operates to determine integrity of the G sets of bits collectively based on the plurality of protection bits. In particular, the plurality of protection bits may be a CRC of the G sets of bits collectively. To determine the integrity of the G sets of bits collectively, the first UE, at operation 1112, determines whether the CRC is correct for the G sets of bits collectively.

At operation 1114, the first UE determines positions of at least one set of bits (e.g., the set including the information bits 912-1 and the protection bits 914-1) within the data bits. At operation 1116, the first UE may determine positions of the rest of the G sets of bits within the data bits. At operation 1118, the first UE operates to process the at least one set of bits of the G sets of bits to obtain downlink control information directed to the first UE. At operation 1120, the first UE may further operate to process sets of the G sets of bits other than the at least one set of bits. Each set of the G sets of bits includes a number of information bits (e.g., the information bits 912-1, 912-2, . . . 912-G) and a number of protection bits (the protection bits 914-1, 914-2, . . . 914-G).

In particular, to process the each set of bits, the first UE, at operation 1122, operates to determine integrity of the number of information bits of the each set of bits based on (a) an identifier (e.g., RNTI) uniquely identifying the first UE in a cell of the base station and (b) the number of protection bits of the each set of bits. More specifically, to determine integrity of the number of information bits of the each set of bits, the first UE, at operation 1124, generates a CRC of the information bits of the each set of bits based on the number of protection bits of the each set of bits and the identifier uniquely identifying the first UE. At operation 1126, the first UE determines whether the CRC is correct for the number of information bits of the each set of bits. At operation 1128, the first UE processes the number of information bits of the each set of bits when the integrity of the number of information bits of the each set of bits is intact.

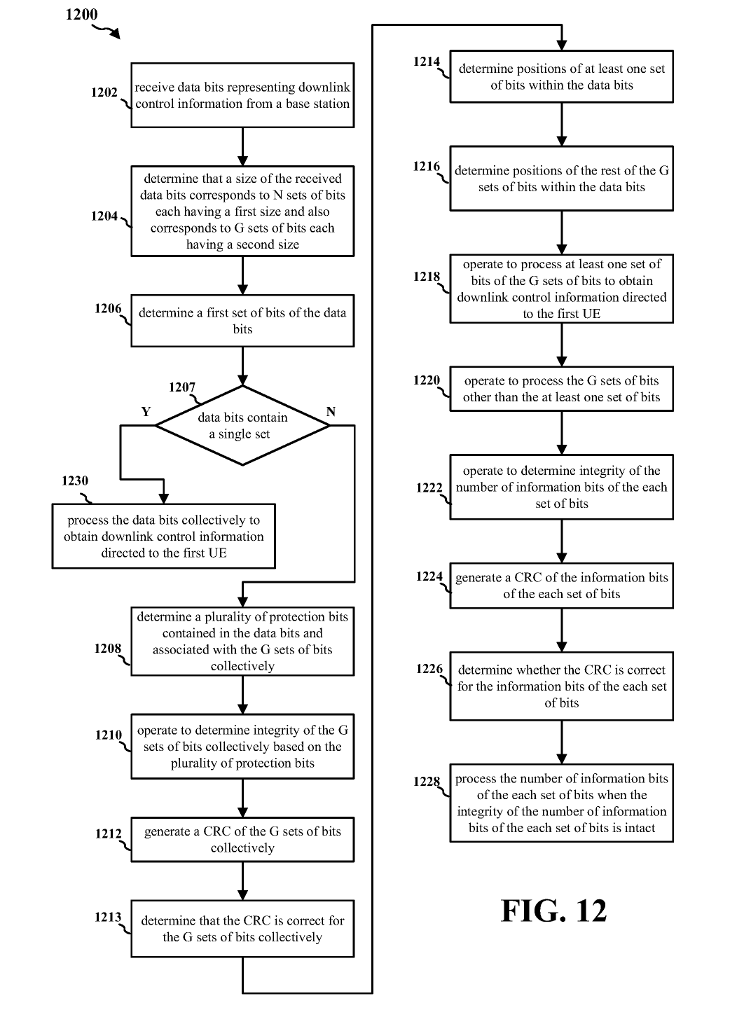

FIG. 12 is a flow chart 1200 of another method (process) for processing aggregated DCI messages. The method may be performed by a first UE (e.g., any of the UEs 804-1, 804-2, . . . 804-G, the apparatus 1302, and the apparatus 1302′). At operation 1202, the first UE receives data bits representing downlink control information from a base station (e.g., the base station 102). In certain configurations, the first UE is pre-configured to monitor the received data bits having one of a list of sizes. At operation 1204, the first UE determines that a size of the received data bits corresponds to N sets of bits each having a first size of the list of sizes and also corresponds to G sets of bits each having a second size of the list of sizes, N being an integer greater than 0, G being an integer greater than 1. The G sets of bits represents downlink control information directed to one or more UEs. At operation 1206, the first UE determines a first set of bits of the data bits. The first set of bits indicates whether the received data bits include the G sets of bits.

At operation 1207, the first UE determines whether the received data bits contain a single set of bits or multiple sets of bits. When the received data bits contain a single set of bits, the first UE, at operation 1230, processes the data bits collectively to obtain downlink control information directed to the first UE.

When the received data bits contain the G sets of bits (e.g., the information bits and the protection bits of the DCI messages 812-1, 812-2, . . . 812-G), the first UE, at operation 1208, determines a plurality of protection bits (e.g., the protection bits 1018) contained in the data bits and associated with the G sets of bits collectively. At operation 1210, the first UE operates to determine integrity of the G sets of bits collectively based on the plurality of protection bits.

In particular, to determine the integrity of the G sets of bits collectively, the first UE, at operation 1212, generates a CRC of the G sets of bits collectively based on the plurality of protection bits and an identifier (e.g., DAG-RNTI) uniquely identifying, in a cell of the base station, a group of UEs (e.g., the UE group 870) including the first UE. At operation 1213, the first UE determines that the CRC is correct for the G sets of bits collectively.

At operation 1214, the first UE determines positions of at least one set of bits (e.g., the set including the information bits 912-1 and the protection bits 914-1) within the data bits. At operation 1216, the first UE may determine positions of the rest of the G sets of bits within the data bits. At operation 1218, the first UE operates to process the at least one set of bits of the G sets of bits to obtain downlink control information directed to the first UE. At operation 1220, the first UE may further operate to process sets of the G sets of bits other than the at least one set of bits. Each set of the G sets of bits includes a number of information bits (e.g., the information bits 912-1, 912-2, . . . 912-G) and a number of protection bits (e.g., the protection bits 914-1, 914-2, . . . 914-G).

In particular, to process the each set of bits, the first UE, at operation 1222, operates to determine integrity of the number of information bits of the each set of bits based on (a) an identifier (e.g., index) uniquely identifying the first UE within the group (e.g., the UE group 870) and (b) the number of protection bits of the each set of bits. More specifically, to determine the integrity of the number of information bits of the each set of bits, the first UE, at operation 1224, generates a CRC of the information bits of the each set of bits based on the number of protection bits of the each set of bits and the identifier uniquely identifying the first UE within the group of UEs. At operation 1226, the first UE determines that the CRC is correct for the information bits of the each set of bits. At operation 1228, the first UE processes the number of information bits of the each set of bits when the integrity of the number of information bits of the each set of bits is intact.

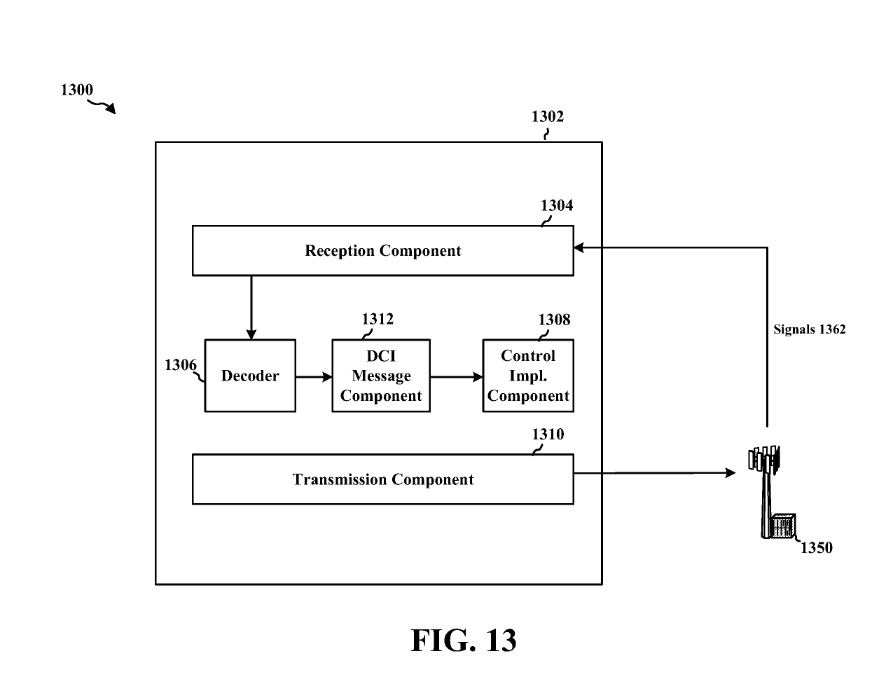

FIG. 13 is a conceptual data flow diagram 1300 illustrating the data flow between different components/means in an exemplary apparatus 1302. The apparatus 1302 may be a first UE. The apparatus 1302 includes a reception component 1304, a decoder 1306, a DCI message component 1312, a control implementation component 1308, and a transmission component 1310. The reception component 1304 may receive signals 1362 from a base station 1350.

In one aspect, the decoder 1306 decodes the signals 1362 to generate data bits representing downlink control information from a base station. In certain configurations, the DCI message component 1312 is pre-configured to monitor the received data bits having one of a list of sizes. The DCI message component 1312 determines that a size of the received data bits corresponds to N sets of bits each having a first size of the list of sizes and also corresponds to G sets of bits each having a second size of the list of sizes, N being an integer greater than 0, G being an integer greater than 1. The G sets of bits represents downlink control information directed to one or more UEs. The DCI message component 1312 determines a first set of bits of the data bits. The first set of bits indicates whether the received data bits include the G sets of bits.

The DCI message component 1312 determines whether the received data bits contain a single set of bits or multiple sets of bits. When the received data bits contain a single set of bits, the DCI message component 1312 processes the data bits collectively to obtain downlink control information directed to the first UE. The DCI message component 1312 sends the downlink control information to the control implementation component 1308, which subsequently operates the first UE in accordance with the downlink control information.

When the received data bits contain the G sets of bits, the DCI message component 1312 determines a plurality of protection bits contained in the data bits and associated with the G sets of bits collectively. The DCI message component 1312 operates to determine integrity of the G sets of bits collectively based on the plurality of protection bits. In particular, the plurality of protection bits may be a CRC of the G sets of bits collectively. To determine the integrity of the G sets of bits collectively, the DCI message component 1312 determines whether the CRC is correct for the G sets of bits collectively.

The DCI message component 1312 determines positions of at least one set of bits within the data bits. The DCI message component 1312 may also determine positions of the rest of the G sets of bits within the data bits. The DCI message component 1312 operates to process the at least one set of bits of the G sets of bits to obtain downlink control information directed to the first UE. The DCI message component 1312 may further operate to process sets of the G sets of bits other than the at least one set of bits. Each set of the G sets of bits includes a number of information bits and a number of protection bits.

In particular, to process the each set of bits, the DCI message component 1312 operates to determine integrity of the number of information bits of the each set of bits based on (a) an identifier uniquely identifying the first UE in a cell of the base station and (b) the number of protection bits of the each set of bits. More specifically, to determine integrity of the number of information bits of the each set of bits, the DCI message component 1312 generates a CRC of the information bits of the each set of bits based on the number of protection bits of the each set of bits and the identifier uniquely identifying the first UE. The DCI message component 1312 determines whether the CRC is correct for the number of information bits of the each set of bits. The DCI message component 1312 processes the number of information bits of the each set of bits when the integrity of the number of information bits of the each set of bits is intact to obtain downlink control information directed to the first UE. The DCI message component 1312 sends the downlink control information to the control implementation component 1308, which subsequently operates the first UE in accordance with the downlink control information.

In another aspect, the decoder 1306 decodes the signals 1362 to generate data bits representing downlink control information from a base station. In certain configurations, the DCI message component 1312 is pre-configured to monitor the received data bits having one of a list of sizes. The DCI message component 1312 determines that a size of the received data bits corresponds to N sets of bits each having a first size of the list of sizes and also corresponds to G sets of bits each having a second size of the list of sizes, N being an integer greater than 0, G being an integer greater than 1. The G sets of bits represents downlink control information directed to one or more UEs. The DCI message component 1312 determines a first set of bits of the data bits. The first set of bits indicates whether the received data bits include the G sets of bits.

The DCI message component 1312 determines whether the received data bits contain a single set of bits or multiple sets of bits. When the received data bits contain a single set of bits, the DCI message component 1312 processes the data bits collectively to obtain downlink control information directed to the first UE. The DCI message component 1312 sends the downlink control information to the control implementation component 1308, which subsequently operates the first UE in accordance with the downlink control information.

When the received data bits contain the G sets of bits, the DCI message component 1312 determines a plurality of protection bits contained in the data bits and associated with the G sets of bits collectively. The DCI message component 1312 operates to determine integrity of the G sets of bits collectively based on the plurality of protection bits.

In particular, to determine the integrity of the G sets of bits collectively, the DCI message component 1312 generates a CRC of the G sets of bits collectively based on the plurality of protection bits and an identifier uniquely identifying, in a cell of the base station, a group of UEs including the first UE. The DCI message component 1312 determines whether the CRC is correct for the G sets of bits collectively.

The DCI message component 1312 determines positions of at least one set of bits within the data bits. The DCI message component 1312 may also determine positions of the rest of the G sets of bits within the data bits. The DCI message component 1312 operates to process the at least one set of bits of the G sets of bits to obtain downlink control information directed to the first UE The DCI message component 1312 may further operate to process sets of the G sets of bits other than the at least one set of bits. Each set of the G sets of bits includes a number of information bits and a number of protection bits.

In particular, to process the each set of bits, the DCI message component 1312 operates to determine integrity of the number of information bits of the each set of bits based on (a) an identifier uniquely identifying the first UE within a group of UEs in a cell of the base station and (b) the number of protection bits of the each set of bits.

To determine the integrity of the number of information bits of the each set of bits, the DCI message component 1312 generates a CRC of the information bits of the each set of bits based on the number of protection bits of the each set of bits and the identifier uniquely identifying the first UE within the group of UEs. The first UE determines that the CRC is correct for the information bits of the each set of bits. The first UE processes the number of information bits of the each set of bits when the integrity of the number of information bits of the each set of bits is intact to obtain downlink control information directed to the first UE. The DCI message component 1312 sends the downlink control information to the control implementation component 1308, which subsequently operates the first UE in accordance with the downlink control information.

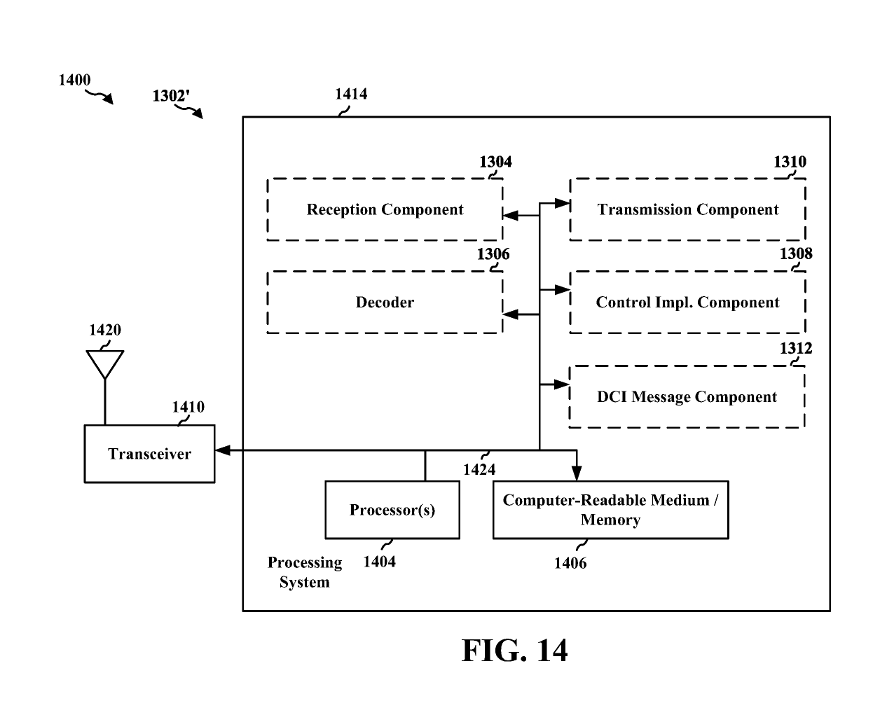

FIG. 14 is a diagram 1400 illustrating an example of a hardware implementation for an apparatus 1302′ employing a processing system 1414. The apparatus 1302′ may be a UE. The processing system 1414 may be implemented with a bus architecture, represented generally by a bus 1424. The bus 1424 may include any number of interconnecting buses and bridges depending on the specific application of the processing system 1414 and the overall design constraints. The bus 1424 links together various circuits including one or more processors and/or hardware components, represented by one or more processors 1404, the reception component 1304, the decoder 1306, the control implementation component 1308, the transmission component 1310, and the DCI message component 1312, and a computer-readable medium/memory 1406. The bus 1424 may also link various other circuits such as timing sources, peripherals, voltage regulators, and power management circuits, etc.

The processing system 1414 may be coupled to a transceiver 1410, which may be one or more of the transceivers 354. The transceiver 1410 is coupled to one or more antennas 1420, which may be the communication antennas 352.

The transceiver 1410 provides a means for communicating with various other apparatus over a transmission medium. The transceiver 1410 receives a signal from the one or more antennas 1420, extracts information from the received signal, and provides the extracted information to the processing system 1414, specifically the reception component 1304. In addition, the transceiver 1410 receives information from the processing system 1414, specifically the transmission component 1310, and based on the received information, generates a signal to be applied to the one or more antennas 1420.

The processing system 1414 includes one or more processors 1404 coupled to a computer-readable medium/memory 1406. The one or more processors 1404 are responsible for general processing, including the execution of software stored on the computer-readable medium/memory 1406. The software, when executed by the one or more processors 1404, causes the processing system 1414 to perform the various functions described supra for any particular apparatus. The computer-readable medium/memory 1406 may also be used for storing data that is manipulated by the one or more processors 1404 when executing software. The processing system 1414 further includes at least one of the reception component 1304, the decoder 1306, the control implementation component 1308, the transmission component 1310, and the DCI message component 1312. The components may be software components running in the one or more processors 1404, resident/stored in the computer readable medium/memory 1406, one or more hardware components coupled to the one or more processors 1404, or some combination thereof. The processing system 1414 may be a component of the UE 350 and may include the memory 360 and/or at least one of the TX processor 368, the RX processor 356, and the communication processor 359.

In one configuration, the apparatus 1302/apparatus 1302′ for wireless communication includes means for performing each of the operations of FIGS. 11-12. The aforementioned means may be one or more of the aforementioned components of the apparatus 1302 and/or the processing system 1414 of the apparatus 1302′ configured to perform the functions recited by the aforementioned means.

As described supra, the processing system 1414 may include the TX Processor 368, the RX Processor 356, and the communication processor 359. As such, in one configuration, the aforementioned means may be the TX Processor 368, the RX Processor 356, and the communication processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a first user equipment (UE), comprising:
receiving data bits representing downlink control information from a base station;
determining a first set of bits of the data bits, the first set of bits indicating whether the received data bits include G sets of bits representing downlink control information directed to one or more UEs, G being an integer greater than 1; and
processing at least one set of bits of the G sets of bits to obtain downlink control information directed to the first UE when the data bits include the G sets of bits.

2. The method of claim 1, wherein the first UE is pre-configured to monitor the received data bits having one of a list of sizes, the method further comprising:
prior to determining the first set of bits, determining that a size of the received data bits corresponds to N sets of bits each having a first size of the list of sizes and also corresponds to the G sets of bits each having a second size of the list of sizes, N being an integer greater than 0.

3. The method of claim 1, further comprising:
processing the data bits collectively to obtain downlink control information directed to the first UE when the data bits include less than two sets of bits each representing downlink control information directed to a UE.

4. The method of claim 1, further comprising: when the data bits include the G sets of bits, prior to the processing the at least one set of bits, determining positions of the at least one set of bits within the data bits.

5. The method of claim 1, further comprising: when the data bits include the G sets of bits,
determining positions of the G sets of bits within the data bits; and
further processing sets of the G sets of bits other than the at least one set of bits.

6. The method of claim 5, wherein each set of bits of the G sets of bits includes a number of information bits and a number of protection bits.

7. The method of claim 6, wherein processing the each set of bits includes:
determining integrity of the number of information bits of the each set of bits based on (a) an identifier uniquely identifying the first UE in a cell of the base station and (b) the number of protection bits of the each set of bits; and
processing the number of information bits of the each set of bits when the integrity of the number of information bits of the each set of bits is intact.

8. The method of claim 7, wherein the determining integrity of the number of information bits of the each set of bits includes:
generating a cyclic redundancy check (CRC) of the information bits of the each set of bits based on the number of protection bits of the each set of bits and the identifier uniquely identifying the first UE; and
determining whether the CRC is correct for the number of information bits of the each set of bits.

9. The method of claim 6, wherein processing the each set of bits includes:
determining integrity of the number of information bits of the each set of bits based on (a) an identifier uniquely identifying the first UE within a group of UEs in a cell of the base station and (b) the number of protection bits of the each set of bits; and
processing the number of information bits of the each set of bits when the integrity of the number of information bits of the each set of bits is intact.

10. The method of claim 9, wherein the determining the integrity of the number of information bits of the each set of bits includes:
generating a cyclic redundancy check (CRC) of the information bits of the each set of bits based on the number of protection bits of the each set of bits and the identifier uniquely identifying the first UE within the group of UEs; and
determining whether the CRC is correct for the information bits of the each set of bits.

11. The method of claim 6, further comprising:
determining a plurality of protection bits contained in the data bits and associated with the G sets of bits collectively; and
determining integrity of the G sets of bits collectively based on the plurality of protection bits.

12. The method of claim 11, wherein the plurality of protection bits are a cyclic redundancy check (CRC) of the G sets of bits collectively, wherein the determining the integrity of the G sets of bits collectively includes:
determining whether the CRC is correct for the G sets of bits collectively.

13. The method of claim 11, wherein the determining the integrity of the G sets of bits collectively includes:
generating a cyclic redundancy check (CRC) of the G sets of bits collectively based on the plurality of protection bits and an identifier uniquely identifying, in a cell of the base station, a group of UEs including the first UE; and
determining whether the CRC is correct for the G sets of bits collectively.

14. An apparatus for wireless communication, the apparatus being a first UE, comprising:
a memory; and
at least one processor coupled to the memory and configured to:
receive data bits representing downlink control information from a base station;
determine a first set of bits of the data bits, the first set of bits indicating whether the received data bits include G sets of bits representing downlink control information directed to one or more UEs, G being an integer greater than 1; and
process at least one set of bits of the G sets of bits to obtain downlink control information directed to the first UE when the data bits include the G sets of bits.

15. The apparatus of claim 14, wherein the first UE is pre-configured to monitor the received data bits having one of a list of sizes, the at least one processor is further configured to:
prior to determining the first set of bits, determine that a size of the received data bits corresponds to N sets of bits each having a first size of the list of sizes and also corresponds to the G sets of bits each having a second size of the list of sizes, N being an integer greater than 0.

16. The apparatus of claim 14, wherein the at least one processor is further configured to:
process the data bits collectively to obtain downlink control information directed to the first UE when the data bits include less than two sets of bits each representing downlink control information directed to a UE.

17. The apparatus of claim 14, wherein the at least one processor is further configured to: when the data bits include the G sets of bits, prior to the processing the at least one set of bits, determine positions of the at least one set of bits within the data bits.

18. The apparatus of claim 14, wherein the at least one processor is further configured to: when the data bits include the G sets of bits,
determine positions of the G sets of bits within the data bits; and
further process sets of the G sets of bits other than the at least one set of bits.

19. The apparatus of claim 18, wherein each set of bits of the G sets of bits includes a number of information bits and a number of protection bits.

20. A computer-readable medium storing computer executable code for wireless communication of a UE, comprising code to:
receive data bits representing downlink control information from a base station;
determine a first set of bits of the data bits, the first set of bits indicating whether the received data bits include G sets of bits representing downlink control information directed to one or more UEs, G being an integer greater than 1; and
process at least one set of bits of the G sets of bits to obtain downlink control information directed to the first UE when the data bits include the G sets of bits.
